(19) United States
(12) Patent Application Publication
(10) Pub. No.: US 2017/0361604 A1
(43) Pub. Date: Dec. 21, 2017

(54) Combined Jet Printing Method

(71) Applicant: Shenzhen Textalk Graphic Technology Co., Ltd., Shenzhen City (CN)

(72) Inventors: Shoubin Wang, Shenzhen City (CN); Wenhong Wang, Shenzhen City (CN); Minxiang Huang, Shenzhen City (CN); Hui Zhang, Shenzhen City (CN)

(21) Appl. No.: 15/229,291

(22) Filed: Aug. 5, 2016

(30) Foreign Application Priority Data
Jun. 16, 2016 (CN) 201610435555.8

(51) Int. Cl. B41J 2/045

(52) U.S. Cl. CPC B41J 2/04501

(57) ABSTRACT

The invention discloses a combined jet printing method comprising preparing at least two inkjet devices, wherein the devices move in a separate manner and implement printing actions separately; preparing at least two mediums to be subject to printing, wherein the number of the mediums is not less than that of the devices; implementing the printing to a medium by the first device; implementing the second printing to the medium which is completely subject to the first printing of the first device by the second device; implementing the N^{th} printing to the medium which is completely subject to the N−1^{th} printing by the N−1^{th} device by the N^{th} device; and finishing the printing after all devices complete all printing actions. The intermittent printing of underpainting and pattern can be realized without needing a screen printing machine, an inkjet printing machine and other equipment, thus reducing cost.

### FIELD OF THE INVENTION

The present invention relates to the field of printing and dyeing, and more particular, to a printing method.

### BACKGROUND OF THE INVENTION

Inkjet printing is a technology that forms patterns in a medium (such as cloth) via jet printing, which is widely applied in the field of clothes processing. The device realizing the inkjet printing is referred to as a printing machine. The printing machine is generally provided with an ink cartridge or an inkjet head as the output end. The patterns are subject to jet printing by moving the ink cartridge or the inkjet head.

The medium darker in color needs to be subject to jet printing with one layer of light-colored underpainting in advance, and then is subject to the pattern on the underpainting, which can avoid the color of the medium from covering up the pattern. In the prior art, the medium is firstly placed on a screen printing machine to print the underpainting and then on an inkjet printing machine for the jet printing of the pattern as a rule. However, this mode needs to purchase two sets of devices including the screen printing machine and the inkjet printing machine, so as to increase the enterprise cost greatly; meanwhile, the medium needs to be transferred among different devices, so as to limit the increase in production efficiency.

### SUMMARY OF THE INVENTION

In order to overcome the disadvantages of the prior art, the invention provides a combined jet printing method, which is used to solve the problem that the quick jet printing of underpainting and pattern fails to be realized in one same set of equipment in the prior art.

In order to solve the technical problems, the invention employs the technical solutions as follows:
A combined jet printing method, comprising the following steps:
S10, preparing at least two inkjet devices, wherein the inkjet devices can move in a separate manner and implement the jet printing actions separately;
S20, preparing at least two mediums to be subject to jet printing, wherein the number of the mediums is not less than that of the inkjet devices;
S30, implementing the jet printing to the medium by the first inkjet device;
S40, implementing the second jet printing to the medium which is completely subject to the first jet printing of the first inkjet device by the second inkjet device;
S40, implementing the Nth jet printing to the medium which is completely subject to the N−1th jet printing of the N−1th inkjet device by the Nth inkjet device; and
S60, finishing the jet printing after all inkjet devices complete jet printing actions;

wherein, step S10 and step S20 are in no particular order.

As a further improvement of the foregoing solution, the combined jet printing method comprises the step of discharging the medium that completes the jet printing in advance and replacing a new medium, wherein the step is synchronously implemented when the inkjet device implements the jet printing to the other mediums, or uniformly implemented after all mediums complete the jet printing.

As a further improvement of the foregoing solution, a cross beam and a power device are provided, the inkjet devices are installed on the cross beam and can be driven by the power device to move along the length direction of the cross beam, the mediums are located below the cross beam and distributed along the length direction of the cross beam.

As a further improvement of the foregoing solution, the power device driving the inkjet device to move is a linear motor, the linear motor comprises a stator installed along the length direction of the cross beam and rotors in the corresponding number equal to that of the inkjet devices, wherein the rotors are connected with the corresponding inkjet devices respectively.

As a further improvement of the foregoing solution, the combined jet printing method comprises the step of moisturizing the inkjet devices before jet printing.

As a further improvement of the foregoing solution, the inkjet devices are firstly subject to flash jet before normal jet printing.

As a further improvement of the foregoing solution, the mediums are firstly subject to the jet coating of pretreatment fluid before printing.

As a further improvement of the foregoing solution, a pretreatment fluid jet coating device is provided, and the mediums can move between the inkjet device and the pretreatment fluid jet coating device.

As a further improvement of the foregoing solution, the combined jet printing method includes the step of measuring the position of the inkjet devices relative to the mediums in the movement process of the inkjet devices and positioning the position between the adjacent inkjet devices.

As a further improvement of the foregoing solution, the cross beam is provided with a magnetic grating or an optical grating parallel to the length direction of the cross beam.

The invention has the advantageous effects that: the intermittent jet printing of underpainting and pattern can be realized by the combined jet printing of at least two inkjet devices capable of implementing jet printing in a separate way, without needing to purchase a screen printing machine, an inkjet printing machine and other various sets of equipment, which is conducive to reducing the enterprise cost; meanwhile, transfer links of a medium among different devices are avoided to improve the production efficiency.

### BRIEF DESCRIPTION OF THE DRAWINGS

The present invention will be further described in details hereunder with reference to the drawings and the embodiments.

FIG. 1 is an exemplary flow diagram of a preferred embodiment of a method according to the invention;

FIG. 2 shows a three-dimensional view of an embodiment of a printing machine according to the invention;

FIG. 3 shows a three-dimensional view of the combination of a cross beam and inkjet devices of the printing machine according to the invention;

FIG. 4 shows an exploded view of the cross beam and the inkjet devices of the printing machine according to the invention; and

FIG. 5 shows a three-dimensional view of an embodiment of the inkjet devices of the printing machine according to the invention.

### DETAILED DESCRIPTION OF THE EMBODIMENTS

The conception, specific structure and generated technical effect of the invention will be described clearly and completely with reference to the embodiments and the drawings hereunder, so as to fully clarify the object, solution and effect of the invention. It should be noted that the embodiments in the application and the features in the embodiment can be mutually combined under the condition without conflict.

It should be noted that unless otherwise specified herein, when a certain feature is called to “fixed” or “connected” to the other feature, it cannot only be directly fixed or connected to the other feature, but also indirectly fixed or connected to the other feature. In addition, the terms such as “up”, “down”, “left”, “right” and the like” herein are merely relative to the mutual position relation of various components of the invention in the drawings.

In addition, unless otherwise defined, the meanings of all technologies and scientific terms used herein are the same as those generally understood by those skilled in the art. The terms used herein are merely for describing the specific embodiment, but not intended to limit the invention. The terms “and/or” used herein include any combination of one or more related listed items.

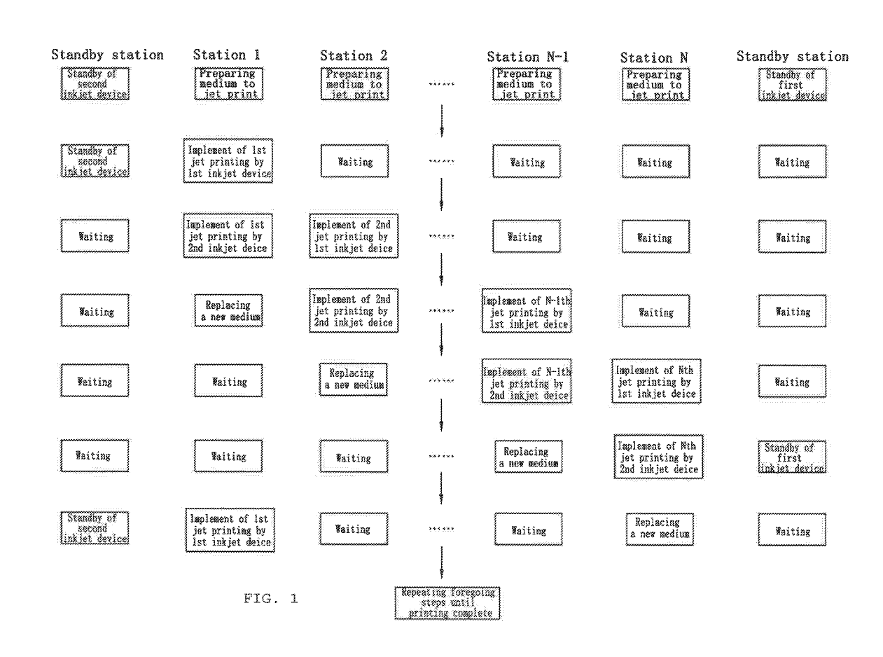

Now referring to FIG. 1, an exemplary flow diagram of one preferred embodiment of the invention is illustrated. The method includes the following steps.
S10, preparing at least two inkjet devices that can implement the jet printing actions separately. The separate actions here include both the separate action of the inkjet and that between the inkjet devices. With respect to the solution of synchronous movement of the inkjet devices and the separate inkjet in the prior art, the inkjet devices according to the invention can both implement the inkjet action separately and move separately to each other.
S20, preparing at least two mediums to be subject to jet printing, wherein the number of the mediums is not less than that of the inkjet devices, and the medium may be cloth, paper or the like.
S30 to S50, after the inkjet devices and mediums being in position, allowing that the first inkjet device firstly implements the first jet printing (generally jet printing of underpainting) of the medium, and then the second inkjet device implements the second jet printing to the medium which is completely subject to the first jet printing by the first inkjet device, the third inkjet device (if provided) implements the third jet printing to the medium which is completely subject to the second jet printing by the second inkjet device, and the Nth inkjet device implements the Nth jet printing to the medium which is completely subject to the N−1th jet printing by the N−1th inkjet device, and so forth.
Preferably, two inkjet devices are employed, wherein the first inkjet device implements the jet printing of underpainting and the second inkjet device implements the jet printing of pattern.
Normally, in a preferred embodiment, the later inkjet device implements the jet printing according to the jet printing order of the previous inkjet device. However, one condition may be concerned in the actual production as follows: the speed of the first jet printing (jet printing of underpainting) is faster while that of the subsequent jet printing is slower, so that the first inkjet device has completed the jet printing of a plurality of mediums when the subsequent inkjet device completes the jet printing of one medium. At this time, the subsequent inkjet device can freely select any medium that has been subject to the first jet printing to implement the subsequent jet printing, but not intended to limit to the jet printing sequence of the first inkjet device.
S60, finishing the jet printing after all inkjet devices complete jet printing actions.
In addition, steps S10 and S20 are in no particular order.

The inkjet devices can employ the routine technique, such as an inkjet carriage and the like. Two inkjet devices can move relatively under the drive of the corresponding power device. The mediums to be subject to jet printing are distributed along the same direction. Preferably, the distances between the adjacent mediums are equal. The inkjet devices can move equidistantly to ensure aligning with the mediums.

The printing machine in prior art is merely provided with one inkjet device generally. However, single inkjet device is hard to meet the requirements of quick jet printing. Therefore, skilled people go on proposing an improved solution, providing two inkjet devices which can move synchronously and can be configured for the inkjet printing of different colors respectively. Two inkjet devices are coordinated together to perform the printing to the mediums, that is to say, two inkjet devices move to one certain medium to be printed, wherein one of the inkjet devices firstly prints one color and then the other thereof prints the other color; after printing completely, two inkjet devices move synchronously to the other medium to be printed once again and the foregoing actions are repeated. But this mode also has defects in that: the time as required for different jet printing steps is inconsistent; for example, the jet printing speed for the first time is usually quicker than the subsequent jet printing speed. In this way, it also needs to wait for completing the inkjet printing by the subsequent inkjet device even if the first inkjet device has completed the current jet printing, which affects the production efficiency seriously. Based on this, the invention further proposes another preferred embodiment, that is to say, the inkjet device can move separately. Thus, the foregoing problem of overlong waiting time can be solved, which is conducive to improve the production efficiency; meanwhile, the inkjet devices and the mediums can be allowed to arrange in multiple manners, but not intended to be limited within linear arrangement.

Preferably, the invention includes the step of discharging the medium that completes the jet printing in advance and replacing a new medium. The step is synchronously implemented when the inkjet device implements the jet printing to the other mediums, or uniformly implemented after jet printing all mediums. The invention preferably employs the former discharging method, so that the medium changing process can be overlapped with the jet printing process, thus saving the time as required for changing the medium.

Preferably, the method disclosed by the invention further includes other auxiliary steps of moisturizing the inkjet devices before jet printing in the standby state, preventing ink from solidifying to block the nozzle, and implementing flash jet by the inkjet device before normal jet printing to observe whether the color of the ink is correct and the ink quantity is sufficient.

Before jet printing, the mediums may also be firstly subject to the jet coating of the pretreatment fluid, so as to improve the jet printing performance.

In addition, the movement process of the inkjet device also includes the steps of measuring the position of the inkjet device relative to the medium and positioning the position between the adjacent inkjet devices. On one hand, the coordination with the platens can be realized for printing; on the other hand, the collision between the inkjet devices 300 can be avoided.

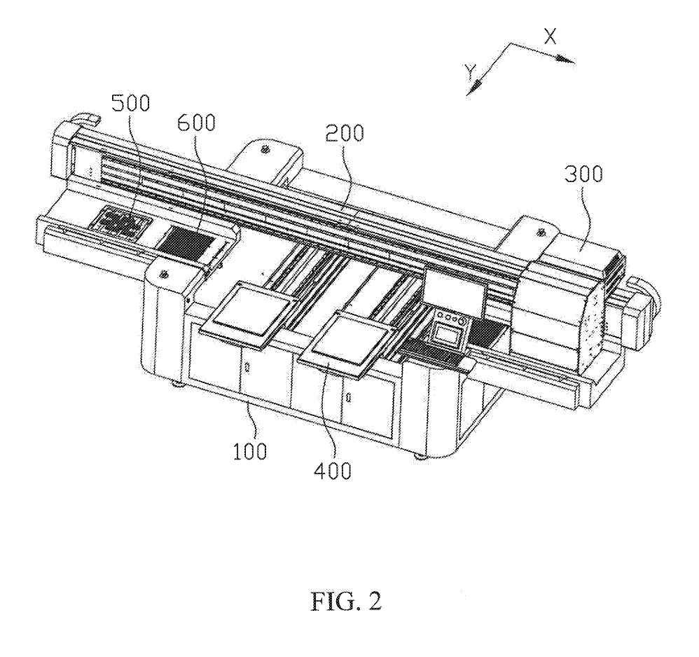

Preferably, the invention discloses a printing machine for implementing the foregoing method. Referring to FIG. 2, a three-dimensional schematic diagram of the printing machine is illustrated. The printing machine includes a rack 100, a cross beam 200, inkjet devices 300 and platens 400, wherein the platens 400 are configured to place and fix the mediums so as to implement the jet printing by the inkjet devices.

The inkjet devices 300 are installed on the cross beam 200 and able to move along the length direction of the cross beam 200 for realizing the printing to the mediums. The platens 400 are installed below the inkjet devices 300 for placing and fixing the mediums to be printed. As shown in figure, the length direction of the cross beam 200 in the embodiment is marked as the direction X, and the horizontal direction perpendicular to the cross beam 200 is marked as the direction Y.

The cross beam 200 is at least provided with two inkjet devices 300; meanwhile, at least two platens 400 are also provided and located below the inkjet devices and distributed along the length direction of the cross beam 200. Taking two inkjet devices 300 and two platens 400 for example, two inkjet devices 300 can move along the length direction of the cross beam 200 under the drive of the power device; meanwhile, the inkjet actions between the inkjet devices 300 are also mutually separate. In this way, the problem in the prior art can be solved by supplying dye (such as white ink) forming the underpainting for one inkjet device 300 and supplying the other dye (such as color ink) forming the pattern for the other inkjet device. To be specific, two inkjet devices 300 (for easy understanding, two inkjet devices are referred to the first inkjet device and the second inkjet device in sequence) moves from one end of the cross beam 200 to the other end thereof. For example, two stations for carrying with the mediums can be installed below the cross beam. Two inkjet devices 200 move from one end of the cross beam to the other end. The first inkjet device performs the jet printing for the medium on the platens located at the front (similarly, two platens are called as the first platen and the second platen in sequence) to form the underpainting, while in the process, the second inkjet device remains stationary. After completing the jet printing of the underpainting for the first time, the first inkjet device continuously moves along the cross beam 200 to the second platen for the continuous jet printing of the underpainting; while the second inkjet device moves to the first platen for the color jet printing of the medium on the platen to form the pattern. After completing the jet printing of the underpainting for the second time, the first inkjet device continuously moves forward to enter the standby position; while the second inkjet device moves to the second platen for the jet printing of the patter. After completing the jet printing, two inkjet devices move backward to the initial position to wait for the next action. It is assumed that the time as required for the jet printing of the underpainting is 10 s and the time as required for the jet printing of the pattern is 20 s. There are two mediums to be subject to jet printing. For the jet printing of the first medium, the time in the existing solution is 30 s which is equal to that as required in the invention. For the printing of the second medium, the total time of jet printing is the adding time as required for all actions as the next jet printing action cannot be taken until the previous jet printing action is completed in the existing solution, i.e., 60 s. According to the invention, the jet printing of the underpainting for the second medium can be implemented after completing that of the underpainting for the first medium. The jet printing of the pattern of the first medium is completed exactly when the jet printing of the underpainting of the second medium is completed (spending 20 s), and the jet printing of the pattern of the second medium can be implemented immediately at this time. The total time is 50 s when completing the jet printing of the underpainting of the second medium. That is to say, the total time in the invention is merely determined by the time-consuming actions. With respect to the mode that the total time is determined by various actions together in the existing solution, the work efficiency is remarkably enhanced, the transfer links of the medium among different equipment can also be saved, which are conducive to improving the production efficiency. Meanwhile, when the second inkjet device prints the medium on the second platen, the medium on the first platen can be replaced by a worker or a mechanical material changing device, that is to say, the medium in the other place is charged and discharged in the printing process of the medium in one place, so as to save the time as required for separately changing the medium, thereby further improving the efficiency. At last, the jet printing of the underpainting and pattern can be realized in one equipment in the invention, without needing to purchase a screen printing machine, an inkjet printing machine and other various sets of equipment, which can reduce the enterprise cost.

In the above embodiments, both of the number of the inkjet devices 300 and platens 400 are two, however the number of both of which can be changed in other embodiments, for example, various platens can be arranged, so as to enable the inkjet device to print more mediums in every working stroke; meanwhile, a plurality of inkjet devices 300 can also be arranged, for example, one inkjet device for the jet printing of underpainting plus with the plurality of inkjet devices for the jet printing of different colors, or other combinations. The number of the inkjet devices 300 can be relatively equal to or different from that of the platens 400 in the invention.

Corresponding to the auxiliary steps involved in the foregoing methods, the printing machine is further provided with different auxiliary stations, including a nozzle moisturizing station 500, a flash jet station 600 and a pretreatment fluid coating station (not shown). As the most preferred embodiment and the device as illustrated in FIG. 2, the nozzle moisturizing station 500 and the flash jet station 600 are installed in the position of a base 100 corresponding to the end portion of the cross beam 200, wherein the nozzle moisturizing station 500 is located outside and the flash jet station 600 is located inside, that is to say, the inkjet device 300 can directly print from the nozzle moisturizing station 500 through the flash jet station 600. More preferably, corresponding to the foregoing two inkjet devices 300, the nozzle moisturizing station 500 and the flash jet station 600 are installed at both ends of the cross beam 200, that is to say, the inkjet devices 300 out of operation remain at both ends of the cross beam 200. If the number of the inkjet devices 300 more than two, the number of the nozzle moisturizing station 500 will be increased accordingly.

The pretreatment fluid coating station is also installed on the rack 100. The platen 400 can move between the cross beam 200 and the pretreatment fluid coating station, that is to say, the mediums before printing are firstly transmitted by the platen 400 to the pretreatment fluid coating station for treatment, and then returns below the cross beam for subsequent printing. Preferably, the platen 400 can move along the direction (i.e., direction Y) perpendicular to the cross beam 200, and the pretreatment fluid coating station and the cross beam 200 are located at both ends of the motion trail of the platen respectively.

Preferably, the platens 400 are driven by the separate power mechanisms respectively, so as to move between the pretreatment fluid coating station and the cross beam 200 in a separate manner. In the embodiment, the platens 400 are driven by a synchronous belt mechanism.

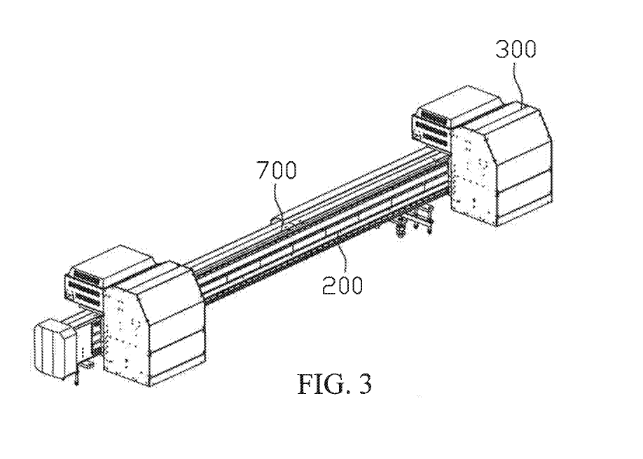

Referring to FIG. 3, a three-dimensional schematic diagram of the combination of the cross beam 200 and the inkjet devices 300 is illustrated. In the figure, the inkjet devices 300 are preferably installed on the side wall of the cross beam 200 and located at the same side of the cross beam. Obviously, there are various positions of the inkjet devices 300 relative to the cross beam, for example, the inkjet devices can be suspended at the bottom portion of the cross beam 200, and the inkjet devices 300 can also be installed at both sides of the cross beam 200.

In addition, the cross beam 200 is further provided with a distance measuring device 700. The distance measuring device 700 can employ a routine technique such as magnetic grating or optical grating. The embodiment preferably employs the magnetic grating, which is used for measuring the position of the inkjet device 300 relative to the cross beam 200. On one hand, the coordination with the platen can be realized for printing; on the other hand, the collision between the inkjet devices 300 can be avoided.

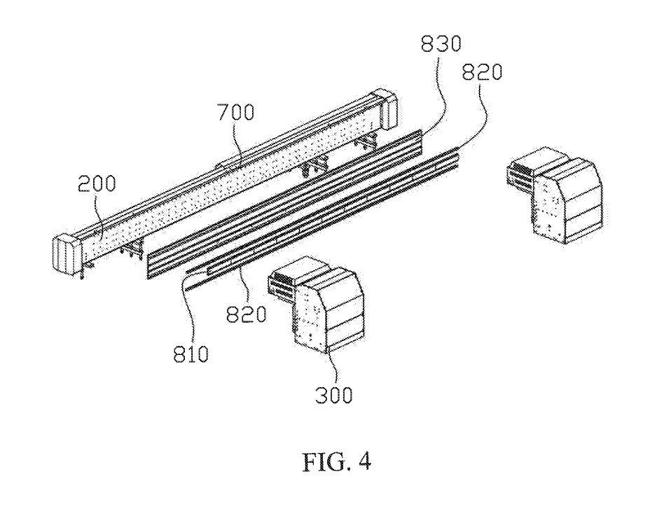

Referring to FIG. 4, an exploded diagram of the cross beam 200 and the inkjet devices 300 are illustrated. A power device for driving the inkjet devices to move is installed between the cross beam 200 and the inkjet device 300. As one optimal embodiment of the power device, the power device is a linear motor, which specifically includes a stator (810) installed along the length direction of the cross beam (as shown in the figure, the stator 810 is installed in the side wall at one side of the cross beam 200; but if the inkjet devices 300 are located at the bottom portion of the cross beam 200 or both sides of the cross beam 200 respectively, the installation position of the stator 810 also needs to be adjusted), and rotors in the number correspondingly equal to that of the inkjet devices 300 (without illustrated in figure). The rotors are connected with the corresponding inkjet devices 200 respectively. The separate motions of the plurality of inkjet devices 300 can be realized by separate power supply or power failure for the rotors. In the prior art, the use of the linear motor is that one stator is corresponding to one rotor. If needing to drive the plurality of devices to move, the conventional method is to provide with various linear motors. The embodiment breaks through the dead zone of the existing means. One set of linear motor can drive various inkjet carriages to move by transforming the common linear motor in the embodiment, which minimizes the volume of the device, greatly reduces the cost, needs no complicated connection structure, and lowers the difficulty of production and installation.

In the embodiment, horizontal guide rails 820 are further provided. Two horizontal guide rails 820 are optimized to be installed at the upper end and the lower end of the stator 810 and parallel to the stator 810. The inkjet device 300 is provided with a horizontal sliding block (without illustrated in figure). The inkjet device 300 can slide relative to the horizontal guide rail 820 via the horizontal sliding block.

To be specific, the stator 810 and the horizontal guide rail 820 are connected with the cross beam 200 via an installation plate 830. The installation plate 830 is fixed on the side wall of the cross beam, and the outer surface thereof is provided with three horizontal installation slots. The stator 810 and the horizontal guide rails 820 are embedded into the corresponding installation slots respectively and locked by fasteners.

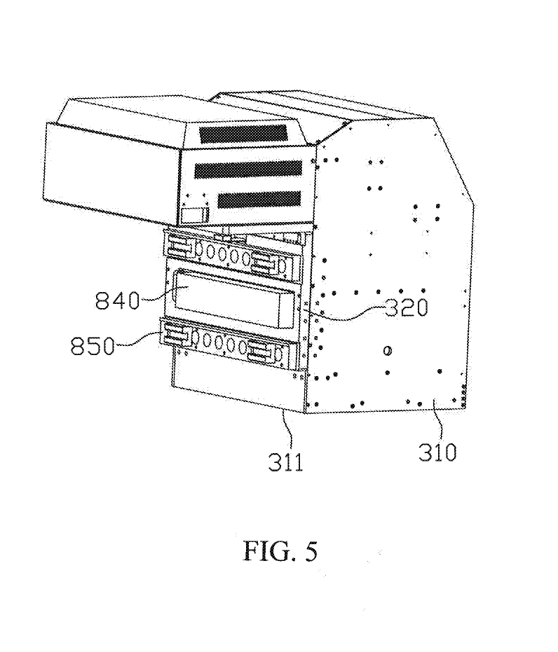

Referring to FIG. 5, an exploded diagram of one embodiment of the inkjet device 300 of the invention is illustrated. The inkjet device 300 includes a housing 310 and a connecting plate 320. The connecting plate 320 is located outside the side wall 310 of the housing 311 and provided with a rotor 840 and a horizontal sliding block 850.

The above is the specific description for the preferred embodiment of the invention, but the the foregoing embodiments are not intended to limit the creation of the invention. Various identical transformations or replacements can further be made by those skilled in the art without departing from the spirit of the invention shall all fall within the scope limited by the claims.

1. A combined jet printing method, comprising the following steps:
S10, preparing at least two inkjet devices, wherein the inkjet devices can move in a separate manner and implement the jet printing actions separately;
S20, preparing at least two mediums to be subject to jet printing, wherein the number of the mediums is not less than that of the inkjet devices;
S30, implementing the jet printing to a medium by the first inkjet device;
S40, implementing the second jet printing to the medium which is completely subject to the first jet printing of the first inkjet device by the second inkjet device;
S50, implementing the Nth jet printing to the medium which is completely subject to the N−1th jet printing of the N−1th inkjet device by the Nth inkjet device; and
S60, finishing the jet printing after all inkjet devices complete all jet printing actions;
wherein, step S10 and step S20 are in no particular order.

2. The method according to claim 1, comprising the step of discharging the medium that completes the jet printing in advance and replacing another medium, wherein the step is synchronously implemented when the inkjet device implements the jet printing to the other medium, or uniformly implemented after all mediums complete the jet printing.

3. The method according to claim 1, wherein a cross beam and a power device are provided, the inkjet devices are installed on the cross beam and can be driven by the power device to move along the length direction of the cross beam, and the mediums are located below the cross beam and distributed along the length direction of the cross beam.

4. The method according to claim 3, wherein the power device driving the inkjet device to move is a linear motor, the linear motor comprises a stator installed along the length direction of the cross beam and rotors in the corresponding number equal to that of the inkjet devices, and wherein the rotors are connected with the corresponding inkjet devices respectively.

5. The method according to claim 1, comprising the step of moisturizing the inkjet devices before jet printing.

6. The method according to claim 1, wherein the inkjet devices are firstly subject to flash jet before normal jet printing.

7. The method according to claim 1, wherein the mediums are firstly subject to the jet coating of pretreatment fluid before printing.

8. The method according to claim 7, wherein a pretreatment fluid jet coating device is provided, and the mediums can move between the inkjet device and the pretreatment fluid jet coating device.

9. The method according to claim 3, comprising the step of measuring the position of the inkjet devices relative to the mediums in the movement process of the inkjet devices and positioning the position between the adjacent inkjet devices.

10. The method according to claim 9, wherein the cross beam is provided with a magnetic grating or an optical grating parallel to the length direction of the cross beam.
